(19) United States
(12) Patent Application Publication
(10) Pub. No.: US 2002/0072562 A1
(43) Pub. Date: Jun. 13, 2002

(54) Methods and compositions for coating a surface

(76) Inventor: Siddhartha Asthana, Elkhart, IN (US)

Correspondence Address: BARNES & THORNBURG, 2600 CHASE PLAZA, 10 LASALLE STREET, CHICAGO, IL, 60603

(21) Appl. No.: 09/916,237

(22) Filed: Jul. 26, 2001

Related U.S. Application Data
(60) Provisional application No. 60/236,472, filed on Sep. 29, 2000.

(51) Int. Cl. B05D 3/02; C08K 3/00

(52) U.S. Cl. 524/560; 427/385.5

(57) ABSTRACT

This invention relates to a method of coating a surface using a primer that increases the adhesion between an after-applied coating and the surface. In particular, this invention relates to a primer composition to improve the adhesion between common building materials and water based coatings.

This invention claims priority from U.S. Ser. No. 60/236,472 which was filed Sep. 29, 2000.

1. Field of the Invention

This invention relates to a method of coating a surface using a primer that increases the adhesion between an after-applied coating and the surface. In particular, this invention relates to a primer composition to improve the adhesion between common building materials and water based coatings.

### BACKGROUND

The use of water-based coatings on the surface of many common industrial and construction materials is sometimes accompanied by the weak adhesion between the paint and the surface. Plastic surfaces, such as EPDM (ethylene propylene diene monomer) and PVC, metal surfaces, such as rusted or galvanized steel, as well as concrete surfaces, often exhibit poor adhesion to water-based paints. Oil based paints and urethane coatings are therefore frequently used on these surfaces instead of water based paints.

On the other hand, water based coatings have several advantages over oil based coatings in many instances. Water based paints have a lower volatile organic compound (VOC) content than oil-based paints, which gives them advantages from an environmental standpoint during their application, clean-up, and the disposal of wastes. Second, water based paints tend to be less expensive and easier to apply than oil based coatings. Finally, even oil-based paints have limited adhesion, and often require a primer or surface pretreatment.

Primer coats are applied to improve the adhesion between the surface and the paint. However, many of the currently available primers also require pre-treatment or post-application treatment when used on plastic surfaces, such as pre-application surface washing or post-application irradiation. Often, these added steps increase the time and cost of coating the surface. Some primers also use additives such as metal catalysts, free radical initiators, and the like, to increase the adhesion between the paint and surface. These additives can increase the production cost of the primer. These additives include lead salts, benzophenone, or other catalysts. Other primers and coating methods are more appropriate for use with articles of manufacture, in that they may require curing the coated surface at an elevated temperature, an oxidizer/acid pretreatment, or irradiation of the surface prior to or following application of the primer or coating.

Finally, most primers of this type are formulated for use with enamels, resin coats and oil based coatings, and do not function to increase adhesion of water based coatings. Therefore, a need exists for primers effective to improve adhesion of water based top-coats.

### SUMMARY

The present invention is directed to an organic solvent based primer composition which increases the adhesion between a surface and an after-applied water based, coating. The primer includes an aprotic acrylic polymer or co-polymer, an organic polyisocyanate and an organic solvent.

In one embodiment of the invention, the polymer component comprises acrylic polymers formed from monomers comprising aprotic acrylate and methacrylate monomers. The amount of polymer component in the primer by weight typically is about 1% to about 20%, preferably about 1% to about 12.1%, and more preferably about 1% to about 8%.

In one embodiment of the invention, the organic polyisocyanate comprises MDI, methylene diphenyl diisocyanate. The amount of polyisocyanate in the primer by weight is about 1% to about 20%, preferably about 2.4% to about 12.1%, and more preferably about 4% to about 12%.

In one embodiment, the primer compositions comprise polymer (P) and polyisocyanate (I) in the ratios (I:P) of about 6:about 1 to about 1:about 4. Preferably, this ratio (I:P) was about 5 :about 1 to about 1:about 1.

The organic solvent is typically a low molecular weight aprotic organic solvent capable of dissolving the polymer and polyisocyanate components. Preferred solvents are low molecular weight (C₄-C₂₀) solvents and halogenated solvents, aromatic solvents, halogenated aromatic solvents, or a mixture of these solvents. Preferred solvents include perchloroethylene, and aromatic solvents such as toluene and xylene.

The method of the present invention for providing a strongly adherent coating includes the steps of adherent applying at least one coat of the primer to the surface, allowing a portion of the solvent component of the primer to evaporate, and applying a water based coating composition to the resulting primer film. The method may also include the steps of applying additional coats or layers of primer, and, when the primer is formulated into a two component system, the method may also include the step of mixing these portions prior to application.

### DETAILED DESCRIPTION OF THE INVENTION

Primer compositions containing a mixture of acrylic polymers, organic polyisocyanates and organic solvents are disclosed, as well as a method for using these primers to increase the adhesion between water based coatings and the surfaces to which the coatings are applied. The primers comprise a solution of a polymer and a polyisocyanate in a hydrocarbon solvent, and are characterized by the unexpected property of increasing the adhesion of water based coatings to untreated plastic and metal surfaces. These primers exhibit good resistance to deleterious environments, and are particularly effective for bonding roofing membranes, composed of cured EPDM, to water based protective coatings.

The primer forms a layer which bonds well to both the surface and the topcoat. The primer contains a polymer which has polar substituent groups, i.e. the ethyl ester of poly(ethyl methacrylate). The polymer also comprises a C-C polymer chain which is hydrophobic in nature and probably engages in hydrophobic interactions with the likewise hydrophobic surface.

The polar substituent groups are more compatible with the polar substituents commonly found in latex and other water based paints and protective coatings. Once applied, the polymer is dispersed upon the surface as the solvent evaporates, forming a matrix upon the surface. The polymer's polar substituents present the after applied coating with a more readily adhesive surface to adhere upon, allowing the primer and coating to engage in polar-polar interactions, as well as hydrogen bond interactions when the appropriate polymer and coating are used. Thus the primer acts as an interface between the polymer and the surface to be coated.

Examples of polymers which have polar substituent groups include PEMA (poly(ethyl methacrylate)) and PMMA (poly(methyl methacrylate)), and poly(butyl acrylate), where the ester of the carboxylic acid acts as the polar substituent group. These ester substituent groups may also participate in hydrogen bonding with carboxylic acid, amine and hydroxyl groups contained in the water based topcoat or coating.

For example, it is recognized that polymers which may be effective for use in the primer include: poly(ethyl acrylate), poly(n-propyl acrylate), poly(iso-propyl acrylate), poly(iso-butyl acrylate), poly(t-butyl acrylate), poly(hexyl acrylate), poly(octyl acrylate), poly(decyl acrylate), poly(iso-decyl acrylate), poly(undecyl acrylate), poly(stearyl acrylate), poly(ethylhexyl acrylate), and aromatic acrylates, poly(methyl methacrylate), poly(ethyl methacrylate), poly(n-propyl methacrylate), poly(iso-propyl methacrylate), poly(n-butyl methacrylate), poly(t-butyl methacrylate), poly(iso-butyl methacrylate), poly(hexyl methacrylate), poly(heptyl methacrylate), poly(octyl methacrylate), poly(2-ethoxyethyl methacrylate), poly(ethylbenzyl methacrylate), poly(decyl methacrylate), poly(hexadecyl methacrylate), poly(undecyl methacrylate), poly(stearyl methacrylate), poly(2-ethoxyethyl methacrylate), aromatic methacrylates, and copolymers of the above mentioned polymers.

It is believed that the organic polyisocyanate works in concert with the polymer to improve the adhesion between the surface and topcoat. When the primer is applied to the surface, the polyisocyanate is dispersed within the polymer matrix. If the surface contains absorbed moisture, i.e. trace amounts of H₂O, the isocyanate groups of the polyisocyanate may react to form a primary amine, which may be mechanically trapped within the surface or chemically bound within the surface. If the surface contains isocyanate reactive and accessible functional groups, these functional groups may react with the isocyanate groups to form carbamate bonds. Functional groups of this type include hydroxyl, carboxylic acid, and amino groups which react with isocyanate groups, i.e. protic groups.

Likewise, if the polymers contained in the water based after-applied coating have reactive hydroxyl, carboxylic acid or amino groups, the isocyanate may also react with these groups. When the isocyanate is mechanically trapped within the polymer matrix, reacting with the surface or the topcoat increases the adhesive strength of the topcoat to the surface. When the poly isocyanate reacts with both the topcoat and the surface, the adhesion between the topcoat and the primer is likewise improved by the actual cross linking of the two materials.

It is also believed that the polymer in the primer may include those which are terminated in isocyanate reactive groups, such that they are mono-functionally isocyanate reactive polymers. These groups include hydroxyl, carboxylic acid, amino and amide groups. It is believed that the head and tail ends of the polymer may migrate into the coating following application of the after-applied coating to the primer on the surface. By placing an isocyanate reactive functional group at the head or tail of the polymer, the polymer may react with the polyisocyanate contained in the primer. If this isocyanate terminated end of the polymer migrates into the newly applied water based coating, the polyisocyanate may also react with an available functional group contained on the polymers comprising the after applied coating, chemically linking the two polymers.

It is recognized that at least one organic polyisocyanate, either aliphatic, cycloaliphatic, or aromatic, or mixtures thereof, may be used. Suitable organic polyisocyanates include methylene diphenyl diisocyanate, (MDI), meta-phenylene diisocyanate, paraphenylene diisocyanate, 2,4′-diphenylmethane diisocyanate, benzidine diisocyanate, napthalene-1,5-diisocyanate, hexamethylene diisocyanate, 4, 4′, 4″-triphenylmethane triisocyanate, decamethylene diisocyanate, polyphenylmethyl polyisocyanates produced by phosgenation of aniline/formaldehyde condensation products, dianisidine diisocyanate, xylylene bis(2-isocyanatoethyl cyclohex-4-ene-1,2-dicarboxylate, bis(2-isocyanatoethyl)carbonate, and many other organic polyisocyanates known in the art, such as those disclosedby Siefken, Amalen, 565:122-135(1949). The organic polyisocyanate used below was a commercially available product, HP 16Q94 (Hehr International Polymers, Decatur, GA) which is composed of MDI (about 50%) and MDI isomers, and sufficient short chain, low molecular weight bifunctional polyols to place the MDI/isomer component in a liquid state at room temperature and pressure. Also, HP 16Q94 contains about 16% NCO content by weight percentage measured against the average molecular weight of the products components. Other commercially available organic polyisocyanate products believed to be effective for use in the invention include Mondur MR (Bayer, Pittsburgh Pa.) and Mondur MR-5 (Bayer, Pittsburg, Pa.).

The solvent component of the primer dissolves the polymer and polyisocyanate components to form a homogeneous primer composition which can be readily applied by standard techniques such as spraying, brushing or rolling. Also, a portion of the solvent evaporates following application of the primer, forming a homogenous matrix or film upon the surface. Taking these properties into account, apolar and aprotic organic solvents, such as perchloroethylene, and aromatic solvents such as SC-100 (an admixture of toluene, xylene and other aromatic solvents manufactured by Exxon Chemical Co., Houston, Tex.) and mixtures of these solvents are particularly effective when used in the primer. Typically, use of perchloroethylene as a solvent reduces the amount of volatile organic compounds (VOCS.) contained in the primer, as perchloroethylene is a non-VOC solvent.

It is also recognized that the primer of the invention includes binary primer compositions, also known as two component primer systems. A binary primer is a primer whose polymer and polyisocyanate are separated into two components (defined as component “A” and component “B” herein for clarity), and mixed prior to use. In this case, component “A” would contain the solvent and polymer components, as well as any pigments, fungicide or other use specific additives, while component “B” would contain the organic polyisocyanate, and possibly sufficient organic solvent to reduce the polyisocyanate's viscosity to an acceptable level for mixing.

As indicated below, the primer compositions were effective when polymer (P) and polyisocyanate (I) were present in the composition in the ratios (I:P) of about 6:about 1 to about 1:about 4. Primers which were particularly effective included those where the polymer:isocyanate ratio was about 5:about 1 to about 1:about 1. Also, the primer compositions were effective when polymer and isocyanate were in the amount of about 1% to about 20% by weight, and were particularly effective when the polymer was in the amount of about 1% to about 8%, and the polyisocyanate was in the amount of about 4% to about 12% by weight.

### EXAMPLES

The following examples are illustrations of the invention, and are not intended to be interpreted as limitations upon the invention. Predetermined amounts of solvent, polymer and polyisocyanate were mixed together using a stirring device for four hours. After mixing, a thin coat of this primer was then spread across EPDM roofing membrane samples and allowed to dry for a predetermined period of time. After the primer has dried, the water based coating was applied on top of this primer and left to dry for a pre- determined time. Samples are summarized in Table 1.

TABLE 1

| | | | | | Adhesion |
|---|---|---|---|---|---|
| | | Weight % | Weight % | Primer | (PLI) |
| | Weight % | Poly(ethyl | polyisocyanate | Drying | (Pounds per |
| Sample | Perchloroethylene | methacrylate) | (HP 16Q94) | Time (Hr) | Linear Inch) |
| 1 | 86.2 | 6.89 | 6.89 | 40 | 16 |
| 2 | 86.2 | 6.89 | 6.89 | 40 | 12 |
| 3 | 86.2 | 6.89 | 6.89 | 40 | 10 |
| 4 | 92.6 | 3.70 | 3.70 | 24 | 7 |
| 5 | 92.6 | 3.70 | 3.70 | 70 | 7 |
| 6 | 86.2 | 6.89 | 6.89 | 24 | 19 |
| 7 | 86.2 | 6.89 | 6.89 | 70 | 17 |
| 8 | 96.15 | 3.84 | 0 | 24 | 0.2 |
| 9 | 96.15 | 3.84 | 0 | 70 | 0.4 |
| 10 | 96.15 | 0 | 3.84 | 70 | 2 |
| 11 | 100 | 0 | 0 | 24 | 0.2 |
| 12 | 100 | 0 | 0 | 70 | 0.4 |
| 13 | 0 | 0 | 0 | 0 | 0.2 |

No primer was applied before applying the water based coating on sample 13 above.

The primer used in samples 6 and 7 in Table 1 was also tested for use on other common construction and industrial surfaces. These results are summarized in Table 2. The primer was left to dry for 40 hours and then water based coating was applied on top of the primer, while testing was performed after allowing the coating to cure for one week at room temperature. The results of these tests are summarized in Table 2 below.

TABLE 2

| | | Weight % | | Primer | |
|---|---|---|---|---|---|
| | Weight % | Poly(ethyl | Weight % | Drying | Adhesion |
| Substrate | Perchloroethylene | methacrylene) | polyisocyanate | Time (Hr) | (PLI) |
| Concrete | 86.2 | 6.89 | 6.89 | 40 | 27 |
| Steel | 86.2 | 6.89 | 6.89 | 40 | 24 |
| Rusted Steel | 86.2 | 6.89 | 6.89 | 40 | 18 |
| Galvanized | 86.2 | 6.89 | 6.89 | 40 | 18 |
| Steel | | | | | |
| Polyvinyl | 86.2 | 6.89 | 6.89 | 40 | 24 |
| chloride | | | | | |
| Modified | 86.2 | 6.89 | 6.89 | 40 | 0.5 |
| Bitumen | | | | | |
| Asphalt | 86.2 | 6.89 | 6.89 | 70 | 1.1 |

These results indicate that primers utilizing perchloroethylene, poly(ethyl methacrylate) and polyisocyanates greatly improved the adhesion of water based coatings to the surfaces of common industrial materials, such as EPDM roofing membrane and polyvinyl chloride plastic substrates.

The following procedures were used in the examples to prepare the primer samples and to test the adhesion between topcoat and primer.

The primer was applied to the test substrate sheets using three different techniques. First, spray application of the primer to the surface was simulated by applying primer to the surface drop-wise from a 3 ml pipette, covering the surface in small droplets. Second, mechanical spreading or brush application of primer was simulated by applying the primer with the 3 ml pipette and then spreading the primer across the surface manually. Finally, primer was also applied to one spot on the surface using a 3 ml pipette and allowed to flow across the surface.

Where drying or setting times are indicated below, the sample was allowed to stand at room temperature (70-75° F.) for the given period of time following the application of the primer or water based coating. To mix the primers components into a solution, solvent(s), polymer(s) and polyisocyanate(s) were placed in an appropriate sized beaker or container and mechanically stirred using a stir bar or other appropriate device until the components were dissolved The polymer components referred to below include PEMA (Aldrich, Milwaukee, Wis.), a commercially available poly(ethyl methacrylate) with a weighted average molecular weight of 250 kDa, ROHAGUM N-80 (Rohm America, Piscataway, N.J.), a commercially available acrylic copolymer of 80% ethyl methacrylate and 20% methyl methacrylate with a weighted average molecular weight of 100 kDa, and ROHAMERE 6782 F (Rohm America, Piscataway, N.J.), a similar acrylic copolymer with a weighted average molecular weight of 100 kDa. Poly(butyl acrylate) was also prepared (Genocure™), with a weighted average molecular weight of 25 kDa.

The adhesion-in-peel test, ASTM Standards C 794-93, Standard Test Method for Adhesion-in-Peel of Elastomeric Joint Sealants, 1993, was adapted as follows to test the adhesive bond between coating, primer and substrate. Samples sheets of EPDM roofing membrane were taken from used roofing membranes. Unless otherwise indicated, these strips were used as the substrate test specimens for the primer.

First, a layer of primer was applied to the substrate surface, leaving a short leader section unprimed, and allowed to dry as indicated. Copper plates (2 or 3 plates as noted below) were placed along the long edges of each sample. Each copper plate measured about 0.021 inches thick. A layer of after applied coating was then applied to the surface, again, leaving the short leader section of the substrate surface uncoated. Next, the aluminum mesh was imbedded into the fresh coating. Finally, additional copper plates (2 or 3 as noted below) were placed on top of the first set of plates and the remainder of the topcoat was applied, ensuring that the thickness of the coating was consistent throughout the tests. Immediately following the drying period specified below for the after applied coating, four lengthwise cuts were made on the substrate specimen, through the coating and aluminum mesh to the surface of the substrate, defining 1 inch wide strips separated by a ⅜ ths inch space. The excess material around strips was removed, leaving 1 inch test strips per ASTM Standards C 794-93 protocol.

An Instron Tensile Tester, Model 4411 (Instron, Canton, Mass.) was employed per the manufacturer's instructions to test the adhesive strength of the coating formed by primer and topcoat. The samples were tests were performed at a cross sectional speed of 2.000 inches/minute, a Sample Rate (pts/sec) of 10.0000, 50%, a Grip Distance of 4.0000 inches and a Specum G.L. of 2.0000 inches. Results were obtained in pounds per linear inch (PLI).

In some cases, along with this numerical PLI data, the adhesive bond between substrate, primer and coating was subjectively measured by observing the failure mode of the coating during the test. Three types of failure mode were observed. Adhesive failure, when the coating peels cleanly away from the primer, or the coating and primer peel cleanly away from the substrate surface, indicated a relatively weaker bond between the layers which separate. Cohesive failure, when coating remains on the surface after the mesh has been peeled away from the substrate, indicates a much stronger bond, and may be quantified with respect the percentage (surface area) of coating remaining on the surface. Finally, substrate failure, where some of the substrate itself remains bonded to the coating imbedded in the mesh when the mesh and substrate are peeled apart, indicated the strongest bond between substrate, primer and coating, one which exceeded the internal cohesion of the substrate.

### Example 1 (A75-17)*

This example illustrates the preparation and use of the primer upon a weathered EPDM surface. Seven primer samples were prepared and applied to weathered EPDM strips. After each strip had dried, a top coat of Tricoat (American Chemical Technologies, Elkhart, Ind.), water based paint, containing co-polymers of acrylic and styrene monomers, a ZN+2 cross-looking agent, and trace methacrylate monomers, was applied in equal thickness to each sample. * Designations in parenthesus are internal indentification numbers.

Primer 1 was prepared with 25 gm of PERC (99% perchloroethylene, Dow Chemical, Midland, Md.), 1 gm PEMA (poly (ethyl methacrylate); Aldrich, Milwaukee, Wis.) and 1 gm of 16Q94, (Hehr International Polymers, Decatur, Ga.), an MDI derived diisocyanate (50% diphenyl methane-diisocyanate (MDI), plus 50% MDI isomers). The EPDM strip was washed with PERC (Dow Chemical, Midland, Md.) for 1 hour prior to the application of Primer 1. Following application, the primer was allowed to dry for 40 hours prior to the application of Tricoat (American Chemical Technologies, Elkhart, Ind.).

Primers 2-4 were prepared with 25 gm PERC, 2 gm PEMA and 2 gm of 16Q94 and were applied to unwashed weathered EPDM strips, but were otherwise identical to primer #1.

Primer 5 was prepared with 25 gm of PERC, (Dow Chemical, Midland, Md.) 2 gm of PEMA, (Aldrich, Milwaukee, Wis.) 2 gm 16Q94, (Hehr International Polymers, Decatur, Ga.) and 1 gm Neoprene. The EPDM (American Chemical Technologies, Elkhart, Ind.) strip was washed with PERC (Dow Chemical, Midland, Md.) for 40 hours prior to application of the primer. Following application, the primer was allowed to dry for 15 hours. Table 3 shows the maximum loads of the primer.

TABLE 3

| | Max. Load |
|---|---|
| Primer # | (PLI) |
| 1 | 12.290 |
| 1 | 11.190 |
| 2 | 16.380 |
| 2 | 19.270 |
| 3 | 9.279 |
| 3 | 4.505 |
| 4 | 8.784 |
| 4 | 6.958 |
| 5 | 3.184 |
| 5 | 2.427 |

### Example 2 (A75-19)

This example further illustrates the preparation and use of the primer upon weathered EPDM surfaces. Five sample primers were prepared using the same components (solvent, polymer and polyisocyanate) as Example 1, primer #1.

Primer 1 contained 50 gm solvent, 2 gm polyisocyanate and 2 gm polymer. Primer 2 contained 50 gm solvent, 4 gm polyisocyanate and 4 gm polymer. Primer 3 contained 25 gm solvent and 1 gm polyisocyanate. Primer 4 contained 25 gm solvent and 1 gm polymer. Primer 5 contained 25 gm solvent.

Primers 1 and 2 were each applied on 6 EPDM strips, three of which had been washed for one hour with solvent, and three of which had not been washed. Primers 3, 4 and 5 were each tested on 2 EPDM strips without washing. The results of adhesion testing in pounds per linear inch (PLI) are reported below in Table 4.

TABLE 4

| Primer | | | Primer | Adhesion | |
|---|---|---|---|---|---|
| # | Primer | EPDM | Drying Time | (PLI) | Failure Mode |
| 1 | 1 | 1 | 24 hrs. | 7 | 40% Cohesive |
| 2 | 1 | 1 | 70 hrs. | 6.6 | 20% Cohesive |
| 3 | 1 | 1 | 70 hrs. | 3.2 | 100% Adhesive |
| 4 | 1 | 2 | 24 hrs. | 16 | 60% Cohesive |
| 5 | 1 | 2 | 20 hrs. | 14 | 20% Cohesive |
| 6 | 1 | 2 | 70 hrs. | | |
| 7 | 2 | 1 | 24 hrs. | 19 | 100% Cohesive |
| 8 | 2 | 1 | 70 hrs. | 17 | 100% Cohesive |
| 9 | 2 | 1 | 70 hrs. | 7 | 20% Cohesive |
| 10 | 2 | 2 | 24 hrs. | 22 | 100% Cohesive |
| 11 | 2 | 2 | 70 hrs. | 20 | 10% Cohesive |
| 12 | 2 | 2 | 70 hrs. | | |
| 13 | 2 | 1 | 70 hrs. | | |
| 14 | 3 | 1 | 70 hrs. | 2 | 100% Adhesive |
| 15 | 4 | 1 | 24 hrs. | 0.2 | 100% Adhesive |
| 16 | 4 | 1 | 70 hrs. | 0.4 | 100% Adhesive |
| 17 | 5 | 1 | 24 hrs. | 0.2 | 100% Adhesive |
| 18 | 5 | 1 | 70 hrs. | 0.4 | 100% Adhesive |
| 19 | No Primer | 1 | 24 hrs. | 0.4 | 100% Adhesive |
| 20 | No Primer | 1 | 24 hrs. | | |

Failure modes is another indicator of the strength of the adhesion between the coating and surface. An adhesive failure implies that the primer coating adhered poorly to the surface, because the entire coating was peeled away from the surface. A cohesive failure, in contrast, implies a stronger adhesion, because the coating breaks cohesively.

### Example 3 (A75-20)

This example illustrates the use of the primer on a variety of surfaces. A sample primer was prepared with the same components as Example 1, primer #1, using 25 gm solvent, 2 gm isocyanate and 2 gm polymer. The sample was mechanically stirred for 4 hours, spread evenly across the surfaces with a tongue depressor and allowed to set for 40 hours before Tricoat (American Chemical Technologies, Elkhart, Ind.) was applied. Samples were first tested one week after application of the coating. Identical samples were tested one month after application of the coating. The results of these tests are summarized in Table 5 below.

TABLE 5

| | Adhesion (PLI) | Adhesion (PLI) | Failure |
|---|---|---|---|
| Substrate | One Week | One Month | Mode |
| EPDM | 20 | not tested | 100% |
| | | | Cohesive |
| Concrete | 27 | 29 | 100% |
| | | | Cohesive |
| Steel | 24 | 28 | 25% |
| | | | Cohesive |
| Rusted Steel | 18 | 21 | 40% |
| | | | Cohesive |
| Galvanized Steel | 18 | 27 | 100% |
| | | | Cohesive |
| Vinyl | 24 | 19 | 100% |
| | | | Cohesive |
| Modified Bitumen | 0.5 | not tested | 100% |
| | | | Adhesive |
| Asphalt | 1.1 | not tested | 100% |
| | | | Adhesive |

### Example 4 (A75-21)

This example illustrates the use of different commercially available methacrylate polymers in the primer solution. Two primer examples were made using commercially obtained polymers. Primer 1 was prepared with 400 gm solvent, 32 gm Rohagum N-80 (Rohm America, Piscataway, N.J.) and 32 gm isocyanate. Primer 2 was prepared with 400 gm solvent, 32 gm Rohamere 6582 F(Rohm America, Piscataway, N.J.) and 32 gm of 16Q94 (Hehr International Polymers, Decatur, Ga,). Fourteen strips of EPDM were coated with the primers, seven for each primer. Tricoat (American Chemical Technologies, Elkhart, Ind.) was applied to samples 1-5 and 8-12 two days after application of the primer. Geotherm (American Chemical Technology, Elkhart, Ind.) was applied to samples 6 and 13 four days after application of the primer, and Gen Acrylic (American Chemical Technology, Elkhart, Ind.) was applied to Sample 7 and 14 four days after application of the primer. Both Geotherm and Gen Acrylic contain co-polymers of styrene and acrylic monomers and Z_{N}⁺² as a cross-linking agent. Adhesion between the coating and the EPDM strips was measured as described above, and the results are summarized in Table 6.

TABLE 6

| Sample | | Primer/Coating | | Failure Mode |
|---|---|---|---|---|
| # | Primer | Drying Times | Adhesion (PLI) | Comments |
| 1 | 1 | 2 days/5 days | 5.2 | 10% |
| | | | | Cohesive |
| 2 | 1 | 2 days/7 days | 20 | 100% |
| | | | | Adhesive |
| 3 | 1 | 2 days/12 days | varied, 5 to 16 | Varied |
| 4 | 1 | 2 days/47 days | 3.3 | 100% |
| | | | | Adhesive |
| 5 | 1 | 2 days/47 days | 5.7 | 50% |
| | | | | Cohesive |
| 6 | 1 | 4 days/14 days | varied, 2 to 12 | Varied |
| 7 | 1 | 4 days/14 days | 5. | — |
| 8 | 2 | 2 days/5 days | 1.3 | 100% |
| | | | | Adhesive |
| 9 | 2 | 2 days/7 days | 1.1 | 100% |
| | | | | Adhesive |
| 10 | 2 | 2 days/47 days | 2.7 | 100% |
| | | | | Adhesive |
| 11 | 2 | 2 days/47 days | 2.4 | 100% |
| | | | | Adhesive |
| 12 | 2 | 2 days/47 days | 2.7 | 100% |
| | | | | Adhesive |
| 13 | 2 | 4 days/49 days | 2.4 | 100% |
| | | | | Adhesive |
| 14 | 2 | 4 days/49 days | 2.7 | 100% |
| | | | | Adhesive |

### Example 5 (A75-22)

This example illustrates the primer method and composition using different drying times for the coating and Rohagum N-80 (Rohm America, Piscataway, N.J.) as the polymer in the primer. A polymer solution was prepared from 1000 gm solvent, 160 gm polymer, and 160 gm isocyanate. The primer was applied to three sheets of weathered EPDM and allowed to set for five days. A layer of Tricoat (American Chemical Technologies, Elkhart, Ind.) was applied and allowed to dry. Sheet 1 was tested after the coating had set for one week, and had a PLI of 3.7. Sheet 2 was tested after the coating had set for two weeks, and had a PLI of 3.7-5.2. Sheet 3 was tested five months after application of the coating and had a PL1 of 3.0 to 4.3.

### Example 6 (A75-24)

This example illustrates the use of the primer using a commercially available blend of aromatic solvents as the primer's solvent. A primer solution was prepared using 1000 gm SC-100 (Exxon Chemical Co., Houston, Tex.), 160 gm Rohagum N-80, (Rohm America, Piscataway, N.J.) and 160 gm 16Q94 (Hehr International, Decatur, Ga.). The polymer went into solution in approximately 2 hours, and was applied to two sheets of weathered EPDM. The primer was allowed to set for four days and a layer of topcoat was applied. For sheet 1, the adhesion between the topcoat and EPDM surface was tested after allowing the topcoat to dry for seven days. Adhesion for this sheet measured 1.9 to 9.7 PLI. Sheet 2 was tested after 14 days, and its adhesion ranged from 3.7 to 5.9 PLI.

### Example 7 (A75-25)

This example illustrates the use of a low cost, low volatile organic compound (VOC) content primer composition. The primer was prepared with 14 gm SC-100, (Exxon Chemical Co., Houston, Tex.), 36 gm PERC (Dow Chemical, Midland, Md.), 4 gm 16Q94, (Hehr International Polymers, Decatur, Ga.) and 4 gm PEMA (Aldrich, Milwaukee, Wis.). The primer was applied to new, unwashed sheets of EPDM and allowed to dry for one day before a coat of Tricoat was applied. After six days, the adhesive strength was tested at 2.4 PLI. After 11 days the adhesive strength was tested at 2.7 PLI.

### Example 8 (A75-28)

This example illustrates how the thickness of the coating affects the strength of the adhesive bond between the surface and topcoat. The primer was prepared with 200 gm of SC-100, (Exxon Chemical Co., Houston, Tex.), 5 gm butyl acrylate (made in the inventor's lab with a Genocure Polymer kit) and 5 gm 16Q94 (Hehr International, Decatur, Ga.). Five sample sheets of weathered EPDM were prepared by applying approximately equal layers of primer to each, and allowing the primer to set for one day.

Samples 1, 4 and 5 were then coated with Tricoat to form a layer with a total wet thickness of about 0.126 inches. Samples 2 and 3 were coated with Tricoat to form a layer with total wet thickness of about 0.084 inches. Twelve days after the application of the Tricoat, the adhesive strength of the topcoat to the EPDM was tested for all samples. Samples 1 and 2 were tested seven days after application of the topcoat. Sample 1 adhesion measured from about 1.3 to 1.5 PLI, sample 2 adhesion was 2.3 PLI, and sample 3 adhesion measured from about 1.7 to 2.0 PLI. Sample 4 adhesion ranged from about 1.5 to 1.8 PLI, and sample 5 adhesion measured about 1.5 to 1.8 PLI.

### Example 8 (A75-29)

This example illustrates the preparation and use of the primer upon a weathered EPDM surface. A sample primer was prepared with 14 gm SC-100, (Exxon Chemical Co., Houston, Tex.) 36 gm PERC, 4 gm PEMA (Aldrich, Milwaukee, Wis.) and 4 gm 16Q94. (Hehr International, Decatur, Ga.). Four sheets of weathered EPDM (0.043 inches thick) were coated with primer and allowed to dry for one day. A uniform thickness of Tricoat (American Chemical Technologies, Elkhart, Ind.) was applied. Eighteen days after application of the Tricoat (American Chemical Technologies, Elkhart, Ind.), the thickness of the sample was measured. The thicknesses of the sheets (EPDM plus primer plus coating) in inches were 0.098, 0.099, 0.089, 0.086, 0.089, 0.099, 0.099, 0.099, 0.089. Average sheet thickness was 0.094, while the pre-application EPDM thickness was 0.043 inches. This implies that the average dry film thickness of the coating (primer plus after-applied paint) was about 0.051 inches. Samples 1 and 2 were tested 19 days after application of the coating, and the results are reported in Table 7 below.

TABLE 7

| Sample | Max Load (PLI) |
|---|---|
| 1 | 3.522 |
| | 4.456 |
| | 2.454 |
| | 3.737 |
| 2 | 6.577 |
| | 4.021 |
| | 8.193 |
| | 7.248 |

Samples 2 and 3 were tested 39 days after application of the coating, and the results are shown in Table 8 below.

TABLE 8

| Sample | Max Load (PLI) |
|---|---|
| 3 | 5.192 |
| | 2.883 |
| | 3.136 |
| | 3.345 |
| 4 | 4.655 |
| | 3.361 |
| | 4.564 |
| | 5.380 |

### Example 9 (A75-30)

This example illustrates the effect of curing time on the adhesion between the topcoat and surface. Primer and samples were prepared as in Example 8, with the exception that 4 gm of Rohagum N-80 (Rohm America, Piscataway, N.J.) was used as the polymer. Also, the samples had an average dry film thickness 0.052. The results are summarized in Tables 9 and 10.

TABLE 9

| Sample | Max Load (PLI) |
|---|---|
| 1 | 5.149 |
| | 5.842 |
| | 4.279 |
| | 4.220 |
| 2 | 5.863 |
| | 6.733 |
| | 6.024 |
| | 5.584 |

TABLE 10

| Sample | Max Load (PLI) |
|---|---|
| 3 | 5.063 |
| | 6.835 |
| | 8.113 |
| | 8.429 |
| 4 | 9.503 |
| | 4.714 |
| | 4.676 |
| | 2.314 |

### Example 10 (A75-31)

This example illustrates the effect of a change in the concentration of the polymer and isocyanate on the adhesion of the coating to the surface, as well as the use of a mixture of solvents. Four primers were prepared using the same polymer, polyisocyanate and solvents as used in Example 8 above. Each primer contained 43.1 gm of solvent [16.7 gm SC-100 (Exxon Chemical Co., Houston, Tex.) and 26.4 gm PERC (Dow Chemical Co., Midland, Mich.)], but with varying amounts of polymer and isocyanate. Tricoat (American Chemical Technologies, Elkhart, Ind.) was applied to the EPDM strips after the primer had been allowed to dry for 1 day, to a uniform thickness of about 0.126 inches (6 Cu plates). EPDM thickness was 0.043, implying that the coating (primer plus after applied paint) had a wet film thickness of 0.083 inches. The amounts of polymer and isocyanate used in the sample primers and results of the adhesion tests performed one week after application of the coating are shown in Table 11 below.

TABLE 11

| Sample | | | | | | Max. Load |
|---|---|---|---|---|---|---|
| # | Measurement | Grams of I | Grams of P | % mass of I | % mass of P | (PLI) |
| | 1 | | | | | 17.120 |
| 1 | 2 | 5 g | 1.9 g | 10% | 3.8% | 15.540 |
| | 3 | | | | | 5.605 |
| | 4 | | | | | 11.620 |
| | 1 | | | | | 9.321 |
| 2 | 2 | 2 g | 4.9 g | 4% | 9.8% | 11.620 |
| | 3 | | | | | 6.260 |
| | 4 | | | | | 4.639 |
| | 1 | | | | | 4.537 |
| 3 | 2 | 1.9 g | 5 g | 3.8% | 10% | 3.844 |
| | 3 | | | | | 3.485 |
| | 4 | | | | | 2.701 |
| | 1 | | | | | 12.990 |
| 4 | 2 | 4.9 g | 2 g | 9.8% | 4% | 13.370 |
| | 3 | | | | | 12.920 |
| | 4 | | | | | 13.130 |

Duplicate samples were retested one month after application of the coating. Sample 1 was impossible to peel off. Sample 2 had a PLI of 6.368 and 6.534. Sample 3 had a PLI ranging between 4.741 and 8.966, and sample 4 had a PLI of 9.616 and 9.697.

### Example 11 (A75-33)

This example illustrates the different techniques used to apply the primer as well as the effect of the number of layers of primer applied to the surface. A sample primer was prepared using 72 gm PERC (Dow Chemical, Midland, Mich.), 28 gm SC 100 (Exxon Chemical, Houston, Tex.), 8 gm Rohagum N-80 (Rohm America, Piscataway, N.J.) and 8 gm 16Q94 (Hehr International Polymers, Decatur, Ga.). Primer was applied to sheets of weathered EPDM sheets as follows.

The first set of sheets (8 total) was sprayed with primer from a household spray bottle. Of the 8 sheets, six were treated with a second layer two hours after application of the first layer, four sheets were treated with a third layer two hours after application of the first layer, and two sheets received a fourth layer 1 hour and 20 minutes after receiving the third layer.

The second set of sheets (2 total) was treated with primer by direct application of the primer from a 3 ml pipette to the surface. The primer was then spread evenly across the surface using a tongue depressor. One sheet was treated with 3 layers, applied at the above intervals, and the second sheet was treated with four layers, also applied with the above intervals. A third set of sheets (5 total) was treated with primer by direct application of the primer from a 3 ml pipette to the surface, without spreading the primer across the surface. One sheet was treated with two layers of primer according to the above intervals, one sheet was treated with three layers of primer, and two sheets received four layers of primer, all at the time intervals described in the previous paragraphs. Finally, two sheets of new EPDM were coated with three and four layers of primer respectively. The primer was spread evenly with a tongue depressor on both new sheets of EPDM. Tricoat was applied to each sheet 21 hours after the last application of primer and allowed to dry for one week. After one week, the adhesion between coating and EPDM sheet was tested, and the results summarized in Tables 12, 13A and B and 14A and B.

TABLE 12

| | | Number | |
|---|---|---|---|
| Primer | | of layers | |
| applied | Sample | on EPDM | Failure Mode |
| sprayed | A | 1 | 100% Adhesive Failure |
| | B | 2 | Partial Cohesive Failure |
| | C | 3 | Substrate Failure |
| | D | 4 | |
| tongue | a | 3 | 100% Adhesive Failure |
| depressor | b | 4 | 100% Cohesive, Failure |
| | | | and Substrate Failure |
| 3 mL | I | 2 | Cohesive Failure |
| pipettes | II | 3 | Partial Cohesive Failure |
| | III | 4 | Substrate Failure |
| tongue | New EPDM “A” | 3 | |
| depressor | New EPDM “B” | 4 | 100% Adhesive failure |

TABLE 13A

| Primer | | Number of layers | Max Load |
|---|---|---|---|
| applied | Sample | of Primer on EPDM | (PLI) |
| sprayed | A | 1 | 3.576 |
| | | | 3.334 |
| | | | 3.807 |
| | | | 3.468 |
| | B | 2 | 6.212 |
| | | | 4.682 |
| | | | 8.242 |
| | | | 6.287 |
| | C | 3 | 9.659 |
| | | | 10.270 |
| | | | 6.003 |
| | | | 7.205 |
| | D | 4 | 5.632 |
| | | | 5.514 |
| | | | 9.106 |
| | | | 5.385 |
| tongue | a | 3 | 5.015 |
| depressor | | | 4.698 |
| | | | 5.782 |
| | b | 4 | 13.370 |
| | | | 12.420 |
| | | | 13.510 |
| | | | 14.920 |
| 3 mL | I | 2 | 5.734 |
| pipettes | | | 5.595 |
| | | | 6.921 |
| | | | 5.927 |
| | II | 3 | 15.910 |
| | | | 19.380 |
| | | | 15.210 |
| | III | 4 | 11.830 |
| | | | 9.578 |
| | | | 18.790 |
| | | | 15.650 |

TABLE 13 B

| Primer | | Number of layers | Max Load |
|---|---|---|---|
| applied | Sample | on EPDM | (PLI) |
| tongue | new EPDM | 3 | 2.244 |
| depressor | | | 1.992 |
| | new EPDM | 4 | 2.491 |
| | | | 2.008 |

Adhesion strength tests were repeated 10 days after the first series of tests and these results are summarized in Tables 14A and B below.

TABLE 14A

| Primer | | Number of layers | Max Load |
|---|---|---|---|
| applied | Sample | on EPDM | (PLI) |
| 3 mL pipettes | A | 1 | 5.090 |
| | | | 3.640 |
| | | | 3.259 |
| | | | 3.796 |
| | B | 2 | 6.684 |
| | | | 5.740 |
| | | | 4.499 |
| | | | 7.076 |
| | C | 3 | 11.940 |
| | | | 6.502 |
| | | | 6.690 |
| | | | 12.420 |
| | D | 4 | 7.200 |
| | | | 5.680 |
| | | | 8.247 |
| | | | 6.642 |
| | III | 4 | 11.830 |
| | | | 9.578 |
| | | | 18.790 |
| | | | 15.650 |

TABLE 14B

| Primer | | Number of layers | Max Load |
|---|---|---|---|
| applied | Sample | on EPDM | (PLI) |
| tongue | New EPDM “A” | 3 | 3.082 |
| depressor | | | 2.438 |
| | | | 3.973 |
| | | | 3.468 |
| | New EPDM “B” | 4 | 2.980 |
| | | | 2.781 |
| | | | 2.953 |
| | | | 2.846 |

### Example 12 (A75-36)

This example illustrates the effect of a change in concentration of the isocyanate and polymer upon the strength of the adhesion between the surface and the coating. A series of primers was prepared, each using 10 gm SC-100 (Exxon Chemical Co., Houston, Tex.) and 15.86 gm PERC (Dow Chemical, Midland, Md.). The mass percentages of 16Q94 isocyanate (“I”; Hehr International Polymers, Decatur, Ga.) and Rohagum N80 polymer (“P”; Rohn America, Piscataway, N.J.) are shown in Tables 15 and 16. The samples were applied to sheets of weathered EPDM using a 3 ml pipette. Approximately 18.5 hours after application of the primers, the EPDM sheets were coated with 0.084 inches of Tricoat (American Chemical Technologies, Elkhart, Ind.) per the protocol (2+2 Cu plates) described above. The strength of adhesion was measured 157 hours later for all three samples. Samples 1 and 2 were tested again 2 weeks later. The results of these tests are shown Tables 15 and 16 below.

TABLE 15

| Sample | | | | | | Max. Load |
|---|---|---|---|---|---|---|
| # | Measurement | Grams of I | Grams of P | % mass of I | % mass of P | (PLI) |
| | Initial condition | | | | | — |
| | 1 | | | | | 4.107 |
| 1 | 2 | 2.4 g | 1.74 g | 8% | 5.8% | 3.823 |
| | 3 | | | | | 3.769 |
| | 4 | | | | | 3.581 |
| | Initial condition | | | | | — |
| | 1 | | | | | 16.560 |
| 2 | 2 | 3.6 g | 0.54 g | 12% | 1.8% | 13.570 |
| | 3 | | | | | 17.930 |
| | 4 | | | | | 11.540 |
| | Initial condition | | | | | — |
| | 1 | | | | | 17.110 |
| 3 | 2 | 3.3 g | 0.84 g | 11% | 2.8% | 17.640 |
| | 3 | | | | | 15.590 |
| | 4 | | | | | 17.840 |

TABLE 16

| Sample | | | | | | Max. Load |
|---|---|---|---|---|---|---|
| # | Measurement | Grams of I | Grams of P | % mass of I | % mass of P | (PLI) |
| | Initial | | | | | — |
| | condition | | | | | |
| | 1 | | | | | 6.819 |
| 1 | 2 | 2.4 g | 1.74 g | 8% | 5.8% | 2.234 |
| | 3 | | | | | 3.957 |
| | 4 | | | | | 2.797 |
| | Initial | | | | | — |
| | condition | | | | | |
| | 1 | | | | | 4.440 |
| 2 | 2 | 3.6 g | 0.54 g | 12% | 1.8% | 2.303 |
| | 3 | | | | | 3.807 |
| | | | | | | 2.851 |

### Example 13 (A75-32)

This example also illustrates the effect of additional layers of primer on adhesion between the topcoat and surface. A primer was prepared with 36 gm PERC, (Dow Chemical, Midland, Mich.) 14 gm SC-100 (Exxon Chemical Co., Houston, Tex.), 4 gm Rohagum-80 (Rohm America, Piscataway, N.J.) and 4 gm 16Q74 (Hehr International Polymer, Decatur, Ga.). The primer was applied to weathered sheets of EPDM, without spreading, using a 3 ml pipette. Sample A sheets received only one layer of primer. Sample B sheets received a second layer of primer 2 hours and 20 after the second layer. Sample C sheets received third layer of primer 2 hrs and 20 minutes after the second layer. Sample D sheets received fourth layer of primer 2 hours and 10 minutes after the third layer. Approximately 22 hours after receiving its final layer of primer, each EPDM sheet was coated with approximately 0.126 inch layer of Tricoat. The adhesion between sheet and coating for each sample was measured one week later. The results of these tests are summarized in Table 17.

TABLE 17

| | Number of | | | |
|---|---|---|---|---|
| | layers on | Measurement | Max. Load | |
| Sample | EPDM | number | (PLI) | Observations |
| A | 1 | 1 | 19.590 | Partial Cohesive |
| | | 2 | 13.960 | Failure |
| | | 3 | 11.760 | |
| | | 4 | 13.350 | |
| B | 2 | 1 | 15.790 | Partial Cohesive |
| | | 2 | 13.300 | Failure |
| | | 3 | 12.460 | |
| | | 4 | 18.390 | |
| C | 3 | 1 | 16.280 | Partial Cohesive |
| | | 2 | 17.490 | Failure and |
| | | 3 | 10.340 | Substrate Failure |
| | | 4 | 7.393 | |
| D | 4 | 1 | 6.846 | Cohesive Failure |
| | | 2 | 5.568 | and Partial Sub- |
| | | 3 | 8.993 | strate Failure |
| | | 4 | 8.403 | |

### Examples 14 (A75-35)

This example illustrates the effect of a change in concentration of isocyanate and polymer on the adhesion of the coating by testing adhesion strength over a period of time. A primer was prepared using 25.86 gm solvent [10 gm SC-100 (Exxon Chemical Co., Houston, Tex.) and 15.86 gm PERC (Dow Chemical Co., Midland, Mich.)], 3 gm 16Q94 (Hehr International Polymers, Decatur, Ga.) and 1.14 gm Rohagum -80 (Rohm America, Piscataway, N.J.). The primer was applied to weathered EPDM sheets (Sample 1-3) and the new EPDM sheets (Samples A & B) using a 3 ml pipette. Approximately 23 hours after application of the primer, Tricoat (American Chemical Technologies, Elkhart, Ind.) was applied to form a 0.084 inch (wet) layer. The results of the tests are recorded in Table 18 below.

TABLE 18

| Sam- | | | | | Max Load |
|---|---|---|---|---|---|
| ple | % mass of I | % mass of P | Time | Observations | (PLI) |
| 1 | 10% | 3.8% | 1 week | 100% Adhesive | 4.687 |
| | | | | Failure | 3.232 |
| | | | | | 2.738 |
| | | | | | 3.919 |
| 1 | 10% | 3.8% | 2 weeks | 100% Adhesive | 4.655 |
| | | | | Failure | 5.691 |
| | | | | | 2.899 |
| | | | | | 3.914 |
| A | 10% | 3.8% | 2 weeks | 100% Adhesive | 2.577 |
| | | | | Failure | 2.164 |
| | | | | | 2.561 |
| | | | | | 2.110 |
| 3 | 10% | 3.8% | 3 weeks | 100% Adhesive | 4.542 |
| | | | | Failure | 3.587 |
| B | 10% | 3.8% | 3 weeks | 100% Adhesive | 2.132 |
| | | | | Failure | 2.336 |

### Example 15

This example illustrates a comparison test performed on two commercially available primers. Primer 9706-9155A (Ashland Chemical, Columbus, Ohio) and PLIOSEAL 9705 (Ashland Chemical, Columbus, Ohio) were applied to oxidized sheets of EPDM using a 3 ml pipette. Tricoat was applied to form a 0.084 inches layer. One day after application of the primer, the coating was allowed to set, for one week, and adhesive strength was measured per standard protocol. The results of these tests are shown in Table 19 below.

TABLE 19

| Sample # | Max Load (PLI) |
|---|---|
| 9706-9155A | 3.313 |
| | 2.486 |
| | 3.345 |
| PLIOSEAL 9705 | 2.642 |
| | 2.583 |
| | 3.544 |
| | 2.282 |

It is recognized that changes or modifications may be made to the illustrative embodiments described herein without departing from the scope of the invention. Therefore, it is intended that the foregoing description shall be interpreted as an illustration of the invention and not as limitations upon the invention.

What is claimed is:

1. A primer for bonding water based coatings to surfaces, comprising an acrylic polymer or copolymer;
an organic polyisocyanate;
and an aprotic organic solvent;
wherein said polymer or copolymer is formed from monomers comprising aprotic acrylate or methacrylate monomers

2. The primer composition of claim 1, wherein the acrylate or methacrylate monomers are selected from the group consisting of ethyl methacrylate, methyl methacrylate, and butyl crylate.

3. The primer composition of claim 1, wherein the acrylate or methacrylate monomers are selected from the group consisting of ethyl acrylate, propyl acrylate, iso-propyl acrylate, butyl acrylate, iso-butyl acrylate, t-butyl acrylate, hexyl acrylate, octyl acrylate, decyl acrylate, iso-decyl acrylate, undecyl acrylate, stearyl acrylate, ethylhexyl acrylate, aromatic acrylates, methyl methacrylate, ethyl methacrylate, n-propyl methacrylate, iso-propyl methacrylate, n-butyl methacrylate, t-butyl methacrylate, iso-butyl methacrylate, hexyl methacrylate, heptyl methacrylate, octyl methacrylate, 2-ethoxyethyl methacrylate, ethylbenzyl methacrylate, decyl methacrylate, hexadecyl methacrylate, undecyl methacrylate, stearyl methacrylate, 2-ethoxyethyl methacrylate, and aromatic methacrylates.

4. The primer composition of claim 1, wherein the solvent comprises perchloroethylene, xylene or toluene.

5. The primer composition of claim 1, wherein the polyisocyanate comprises methylene diphenyl diisocyanate.

6. The primer composition of claim 1, wherein the polyisocyanate is selected from the group consisting of meta-phenylene diisocyanate, paraphenylene diisocyanate, 2,4′-diphenylmethane diisocyanate, benzidine diisocyanate, napthalene-1,5-disocyanate, hexamethylene diisocyanate, 4,4′, 4″-triphenylemethane triisocyanate, decamethylene diisocyanate, poly phenylmethyl polyisocyanates that are produced by phosgenation of aniline/formaldehyde condensation products, dianisidine diisocyanate, xylene bis(2-isocyanatoethylcyclohex-4-ene-1,2-dicarboxylate, bis(2-isocyanatoethyl) carbonate and methylene diphenyl diisocyanate.

7. The primer composition of claim 1, wherein the primer contains about 70% to about 90% organic solvent, about 1% to about 20% polymer, and about 1% to about 20% polyisocyanate by weight.

8. The primer composition of claim 1, wherein the polymer and the polyisocyanate components are in the ratio (polymer:polyisocyanate) of about 6: about 1 to about 1:about 4 by weight.

9. A primer for improving the adhesion between a surface and an after-applied coating having isocyanate reactive moieties, said primer comprising,
an aprotic organic solvent comprising perchloroethylene, zylene or toluene;
an organic polyisocyanate, comprising methylene diphenyl diiscocyanate; and
an aprotic acrylic polymer or copolymer formed from monomers selected from
the group consisting essentially of aprotic acrylate and methacrylate monomers.

10. The primer composition of claim 9, wherein the composition contains about 80% to about 88% organic solvent, about 1 to about 8% polymer, and about 4% to about 12% polyisocyanate by weight.

11. The polymer composition of claim 9, wherein the primer composition contains about 80 to about 88% organic solvent, about 5 to about 8% polymer and about 5 to about 12% polyisocyanate.

12. A method for forming an adherent water based coating on a surface, comprising the steps of:
applying to the surface the primer composition of claim 1;
allowing at least a portion of the organic solvent to evaporate; and
applying a water based coating to the resulting primer film.

13. The method of claim 12, wherein the acrylate or methacrylate monomers are selected from the group consisting of ethyl methacrylate, methyl methacrylate, and butyl crylate.

14. The method of claim 12, wherein the solvent of the primer comprises perchloroethylene, xylene or toluene.

15. The method of claim 12, wherein the polyisocyanate of the primer comprises methylene diphenyl diisocyanate.

16. The method of claim 12, wherein the polyisocyanate of the primer is selected from the group consisting of meta-phenylene diisocyanate, paraphenylene diisocyanate, 2,4′-diphenylmethane diisocyanate, benzidine diisocyanate, napthalene-1,5-disocyanate, hexamethylene diisocyanate, 4,4′, 4″-triphenylemethane triisocyanate, decamethylene diisocyanate, poly phenylmethyl polyisocyanates that are produced by phosgenation of aniline/formaldehyde condensation products, dianisidine diisocyanate, xylene bis(2-isocyanatoethylcyclohex-4-ene-1,2-dicarboxylate, bis(2-isocyanatoethyl) carbonate and methylene diphenyldiisocyanate.

17. The method of claim 12, wherein the primer contains about 70% to about 90% organic solvent, about 1% to about 20% polymer, and about 1% to about 20% polyisocyanate by weight.

18. The method of claim 12, wherein the polymer and the polyisocyanate components of the primer are in the ratio (polymer:polyisocyanate) of about 6 :about 1 to about 1:about 4 by weight.

19. The method of claim 12, wherein the primer composition is formulated as a two component system wherein a first component comprises a solution of the polymer and organic solvent, and a second component comprises the organic polyisocyanate.

20. The method of claim 19, further comprising the step of mixing the solvent and polymer component with the isocyanate component.
